(19) United States
(12) Patent Application Publication
(10) Pub. No.: US 2012/0051055 A1
(43) Pub. Date: Mar. 1, 2012

(54) RETROFIT SYSTEM FOR CONVERTING AN EXISTING LUMINAIRE INTO A SOLID STATE LIGHTING LUMINAIRE

(75) Inventors: Rick Kauffman, Buford, GA (US); Donald Sipes, Colorado Springs, CO (US); Donald VanderSluis, Sarasota, FL (US); Robert Fugerer, Lutz, FL (US)

(73) Assignee: SUNOVIA ENERGY TECHNOLOGIES, INC., Sarasota, FL (US)

(21) Appl. No.: 13/318,071

(22) PCT Filed: Apr. 28, 2010
(86) PCT No.: PCT/US10/32857

§ 371 Date: Oct. 28, 2011

Related U.S. Application Data
(60) Provisional application No. 61/173,545, filed on Apr. 28, 2009.

(51) Int. Cl. F21V 21/00; F21V 29/00

(52) U.S. Cl. 362/249.02; 362/249.01

(57) ABSTRACT

A luminaire for re-use, a retro-fit device, or mechanism, that are designed to both fit into an existing luminaire while also making efficient use of LEDs or other solid state light elements is provided. Thermal elements are provided that act to remove heat generated by light elements. A housing is provided that may be configured to receive LEDs, or other optical elements, that are aimed to provide light in a desired direction through mounting to a facet or mounting surface, and have effective thermal environment control through one or more fins mounted to the side of the facet opposite the light element. Luminaires are provided for both original designs that utilize solid state light elements, and retrofit assemblies designed to convert an existing luminaire (that uses a traditional light source or sources) into a luminaire that uses solid state light elements.

### CROSS-REFERENCE TO RELATED APPLICATIONS

This application claims priority to U.S. Provisional Patent Application No. 61/173,545, filed on Apr. 28, 2009, the entire disclosure of which is incorporated herein by reference.

This application is also related to co-pending U.S. patent application Ser. No. 12/767,698, filed on Apr. 26, 2010, entitled “Solid State Lighting Unit Incorporating Optical Spreading Elements; U.S. patent application Ser. No. ______, filed on Apr. 28, 2010, entitled “Solid State Luminaire With Reduced Optical Losses,” and identified as Attorney Docket No. 51119.830011.US1; and U.S. patent application Ser. No. ______, filed on Apr. 28, 2010, entitled “Solid State Luminaire Having Precise Aiming and Thermal Control,” and identified as Attorney Docket No. 51119.830012.US1. The disclosures of each of these related applications are incorporated herein by reference.

### FIELD

The present disclosure relates to solid state lighting, and, more particularly, to systems and methods for converting non-solid state lighting fixtures to solid state lighting fixtures.

### BACKGROUND

Lighting systems traditionally use various different types of illumination devices, commonly including incandescent lights, fluorescent lights, and Light Emitting Diode (LED) based lights. LED based lights generally rely on multiple diode elements to produce sufficient light for the needs for a particular application of the particular light or lighting system. As an approach to offset the ever increasing price of energy and make a meaningful indent to the production of greenhouse gases, LED lighting offers great promise in this regard. With efficacies approaching 150 lumens per Watt, and lifetimes at over 50,000 Hours, LEDs and lighting products based on LED technology may potentially make significant inroads in the lighting market in residential and commercial, indoor and outdoor applications.

LED based lights offer significant advantages in efficiency and longevity compared to, for example, incandescent sources, and produce less waste heat. For example, if an ideal solid-state lighting device were to be fabricated, the same level of luminance can be achieved by using merely 1/20 of the energy that an equivalent incandescent lighting source requires. LEDs offer greater life than many other lighting sources, such as incandescent lights and compact fluorescents, and contain no environmentally harmful mercury that is present in fluorescent type lights. LED based lights also offer the advantage of instant-on and are not degraded by repeated on-off cycling.

As mentioned above, LED based lights generally rely on multiple LED elements to generate light. An LED element, as is well known in the art, is a small area light source, often with associated optics that shape the radiation pattern and assist in reflection of the output of the LED. LEDs are often used as small indicator lights on electronic devices and increasingly in higher power applications such as flashlights and area lighting. The color of the emitted light depends on the composition and condition of the semiconducting material used to form the junction of the LED, and can be infrared, visible, or ultraviolet.

Within the visible spectrum, LEDs can be fabricated to produce desired colors. For applications where the LED is to be used in area lighting, a white light output is typically desirable. There are two common ways of producing high intensity white-light LED. One is to first produce individual LEDs that emit three primary colors (red, green, and blue), and then mix all the colors to produce white light. Such products are commonly referred to as multi-colored white LEDs, and sometimes referred to as RGB LEDs. Such multi-colored LEDs generally require sophisticated electro-optical design to control the blend and diffusion of different colors, and this approach has rarely been used to mass produce white LEDs in the industry to date. In principle, this mechanism has a relatively high quantum efficiency in producing white light.

A second method of producing white LED output is to fabricate a LED of one color, such as a blue LED made of InGaN, and coating the LED with a phosphor coating of a different color to produce white light. One common method to produce such and LED-based lighting element is to encapsulate InGaN blue LEDs inside of a phosphor coated epoxy. A common yellow phosphor material is cerium-doped yttrium aluminum garnet (Ce3+:YAG). Depending on the color of the original LED, phosphors of different colors can also be employed. LEDs fabricated using such techniques are generally referred to as phosphor based white LEDs. Although less costly to manufacture than multi-colored LEDs, phosphor based LEDs have a lower quantum efficiency relative to multi-colored LEDs. Phosphor based LEDs also have phosphor-related degradation issues, in which the output of the LED will degrade over time. Although the phosphor based white LEDs are relatively easier to manufacture, such LEDs are affected by Stokes energy loss, a loss that occurs when shorter wavelength photons (e.g., blue photons) are converted to longer wavelength photons (e.g. white photons). As such, it is often desirable to reduce the amount of phosphor used in such applications, to thereby reduce this energy loss. As a result, LED-based white lights that employ LED elements with such reduced phosphor commonly have a blue color when viewed by an observer.

Various other types of solid state lighting elements may also be used in various lighting applications. Quantum Dots, for example, are semiconductor nanocrystals that possess unique optical properties. The emission color of quantum dots can be tuned from the visible throughout the infrared spectrum. This allows quantum dot LEDs to create almost any output color. Organic light-emitting diodes (OLEDs) include an emitting layer material that is an organic compound. To function as a semiconductor, the organic emitting material must have conjugated pi bonds. The emitting material can be a small organic molecule in a crystalline phase, or a polymer. Polymer materials can be flexible; such LEDs are known as PLEDs or FLEDs.

In an ideal situation, luminaires may be designed to optimally incorporate LEDs and make full use of the various properties and advantages for the particular LED that is incorporated into the luminaire. However, in many cases it may be desirable to retrofit an existing light housing to incorporate a solid state light unit. For example, it may desired to preserve the housing of a luminaire for re-use so as to avoid the cost of completely replacing the entire light housing, which can have considerable cost.

### SUMMARY

The present disclosure provides embodiments of a luminaire for re-use, a retro-fit device, or mechanism, that are designed to both fit into an existing luminaire while also making optimal use of LEDs or other solid state light element. Embodiments provide thermal elements that act to remove heat generated by light elements. A housing is provided, in some embodiments, that is configured to receive LEDs, or other optical elements, that are aimed to provide light in a desired direction through mounting to a facet, and have effective thermal environment control through one or more fins mounted to the side of the facet opposite the light element. Embodiments include both luminaires originally designed to utilize solid state light elements, or in retrofit assemblies designed to convert an existing luminaire that uses a traditional light source or sources into a luminaire that uses solid state light elements.

In one aspect, the present disclosure provides a solid state lamp assembly adapted to replace an existing non-solid state lamp assembly installed in a street light, comprising: (a) an aiming platform adapted to be mounted to an existing mounting assembly of a street light, comprising a plurality of mounting surfaces, the plurality of mounting surfaces each comprising a generally planar surface on a first side and a heat dissipating element on a second side; (b) at least one solid state light element mounted to the first side of each mounting surface, each of at least a subset of the plurality of light elements providing light output along a respective primary axis that intersects a centerline of the housing, the output of the plurality of solid state light elements combining to provide an output illumination pattern. The solid state light elements may comprise one or more light emitting diodes (LEDs). The LEDs, in an embodiment, are mounted to thermally conductive printed circuit boards mounted on the first side of respective mounting surfaces. One or more, or all, of the solid state light elements further comprise secondary optics, such as a collimator. An external protective lens may be mounted to the aiming platform.

In some embodiments, the planar surfaces of the first side of the mounting surfaces each have different angles relative planar surfaces of other of the plurality of mounting surfaces. The aiming platform of various embodiments is adapted to be mounted in place of a pre-existing refractor a luminaire, such as a cobra head street luminaire. In one embodiment, the aiming platform meets the mechanical mounting requirements of a refractor in a cobra head luminaire according to American National Standards Institute standard ANSI C136.17-2005.

In one embodiment, the heat dissipating element comprises a heat dissipating fin located on the second side of the mounting surface. Such a heat dissipating fin may comprise one or more apertures to secure the solid state light element to the first side of the mounting surface. Such a heat dissipating fin may also provide additional structural support to the respective mounting surface.

In a further embodiment, an array of solid state light elements are mounted to the first side of at least one of the plurality of mounting surfaces. Each light element of the array of solid state light elements may provide light output along a primary axis that is substantially parallel to the primary axis of the other solid state light elements in the array.

In yet a further embodiment, a power supply is located on a top surface of the housing and electrically interconnected in power supplying communication with each of the solid state light elements. An adaptor cable may be used to connect the power supply to an existing power connection for a street lamp assembly.

Another aspect of the present disclosure provides a lamp assembly, comprising: (a) a housing adapted to be mounted in place of a refractor in an existing street light fixture and comprising a plurality of mounting surfaces that each have a first side and a second side; (b) a plurality of heat dissipation elements located on the second sides of the mounting surfaces; and (c) a plurality of solid state light elements mounted to the first sides of the mounting surfaces, each the plurality of light elements providing light output along a respective primary axis that is substantially orthogonal to a respective plane of the first side, the output of the plurality of solid state light elements combining to provide an output illumination pattern. The street light fixture may be a cobra head street light, and the housing may meets the mechanical mounting requirements of a refractor in a cobra head luminaire according to American National Standards Institute standard ANSI C136.17-2005. In one embodiment, an array of solid state light elements are mounted to the first side of at least one of the plurality of mounting surfaces. Each solid state light element of the array of solid state light elements may provide light output along a primary axis that is substantially parallel to the primary axis of the other solid state light elements in the array.

### BRIEF DESCRIPTION OF THE DRAWINGS

FIG. 1 is a bottom perspective view of a solid state lighting assembly of an exemplary aspect of the disclosure;

FIG. 2 is a bottom perspective view of a solid state lighting assembly and associated external lens of an exemplary aspect of the disclosure;

FIG. 3 is a top perspective view of a solid state lighting assembly of an exemplary aspect of the disclosure;

FIG. 4 is a bottom perspective view of a solid state lighting assembly of an exemplary aspect of the disclosure mounted into an existing street light fixture;

FIG. 5 is a top perspective view of a solid state lighting assembly of an exemplary aspect of the disclosure mounted into a lower luminaire housing of an existing street light fixture;

FIG. 6 is a top view of a solid state lighting assembly of an exemplary aspect of the disclosure mounted into a lower luminaire housing of an existing street light fixture;

FIG. 7 is a side view of a solid state lighting assembly of an exemplary aspect of the disclosure mounted into a lower luminaire housing of an existing street light fixture;

FIG. 8 is a cross-sectional illustration of the solid state lighting assembly of FIG. 7; and

FIG. 9 is an illustration of a secondary optic of various embodiments.

### DETAILED DESCRIPTION

One very common type of street lamp luminaire is referred to as the “cobra head” luminaire, and uses traditional light sources such as metal halide and sodium vapor lamps. Luminaires based on LEDs have several advantages over traditional light sources, among them, longevity, energy efficiency and physical robustness. Optimal use of those LEDs requires designing the optics and the thermal environment around LEDs' characteristics. In order to optimally use LEDs in an existing housing, such as the housing of a cobra head luminaire, all those design requirements must be incorporated into a retro-fit device or mechanism that itself can then be installed into an existing housing.

The present disclosure recognizes that in order to retro-fit an existing luminaire cost-effectively, this replacement assembly should be as self-contained as possible and have a size and shape that enables as close to a universal fit as possible. Optimally, it would meet a known, established standard for some component of the existing housing, such as the traditional cobra head luminaire, that is itself already easily replaceable.

In one embodiment, a replacement assembly is provided for a traditional cobra head luminaire. One component of the traditional cobra head luminaire that meets those criteria is the outer, protective lens commonly known as the refractor. The existing standard that puts forth the mechanical requirements for refractors in cobra head luminaires is ANSI C136.17-2005. This American National Standards Institute standard as published by the National Electrical Manufacturers Association (NEMA) provides guidance on the specific mechanical dimensions of the refractors used in cobra head luminaires (described as “horizontal-burning HID luminaires” in the standard) so as to allow interchangeability of the refractor from one manufacturer to the next.

Embodiments provided herein include an LED retro-fit device or mechanism specifically intended to meet ANSI C136.17-2005 by being designed with the appropriate mechanical dimensions necessary so as to fit in place of an existing refractor on a cobra head (horizontal-burning HID) luminaire. This retro-fit device or mechanism is constructed to be a drop-in replacement for the refractor already installed in a cobra head once the existing light source, reflector, refractor and associated components are removed.

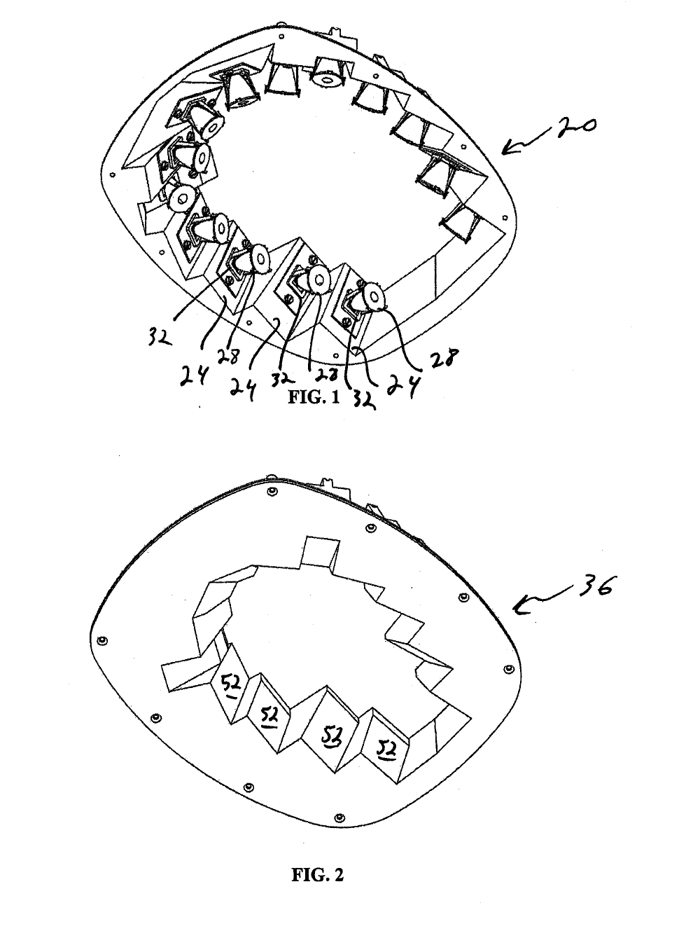

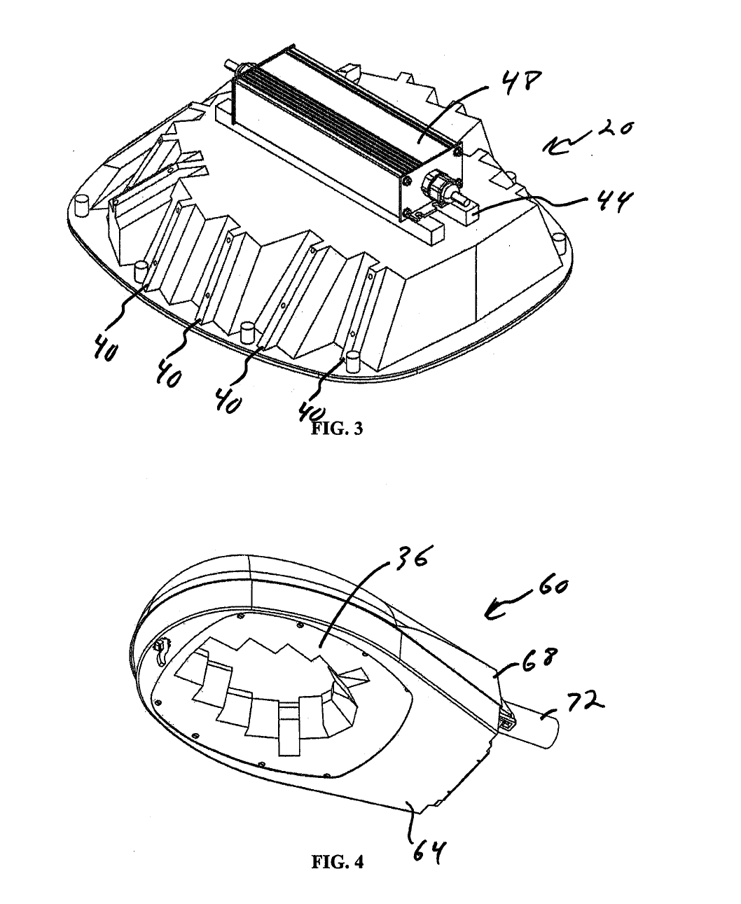

As illustrated in FIG. 1, a retrofit kit of this embodiment includes an aiming platform 20, which is shown as a single piece with multiple inside facets 24, also referred to as mounting surfaces 24, light sources 28, which may include LEDs, are mounted to thermally conductive printed circuit boards (PCBs) 32. The light sources 28, as mentioned, may include one or more LED light elements and secondary optics for some or all of the LEDs. An external protective lens 36 sized and shaped to correspond to the aiming platform 20 is illustrated in FIG. 2.

Each facet 24 of the aiming platform 20 is oriented so as to be orthogonal to the primary aiming axis or vector of each light source 28 and any associated secondary optic or optics. The PCBs 32 are mounted to the inside facets 24 of the aiming platform 20. The facets 24 of the aiming platform are arranged to achieve the desired pattern of light on the ground or other surface that is to be illuminated by the luminaire through the aiming of associated light sources to different portions of the area to be illuminated.

Incorporated into the outside of each facet 24 of the aiming platform 20 is a fin 40 that allows dissipation of the heat generated by the associated light source(s), and is best seen in the illustration of FIG. 3. Each fin 40 may include one or more apertures that facilitate the mounting of light sources to the interior surface, through any appropriate fastener such as a screw, nut and bolt assembly, rivet, etc. Incorporated into the outside of the aiming platform 20 is a mounting area 44 configured to allow mounting of a power supply 48 or power supplies needed to power the light sources. The power supply 48 is configured to receive AC power from an AC power source that is present at an existing street light. In one embodiment, the power supply 48 is connected through a power cable and an electrical fixture that is designed to plug into an existing power receptacle just as the electrical connection of the traditional light source that was previously used in the street light. The power supply 48 includes an AC to DC converter that converts the input AC power to the appropriate DC power required by the solid state light sources 28. In some embodiments, the power supply 48 is adjustable to provide different levels of DC power based on the requirements for the light sources 28.

The light sources 28, including any associated optics, as mentioned, in turn are covered by an external protective lens 36, otherwise known as a refractor. In this embodiment, the lens 36 is shown as faceted, with each facet 52 orthogonal to the aiming axis of the associated light source 28. Other refractor shapes, such as a flat shaped refractor, may be employed depending on requirements for particular applications of the luminaire.

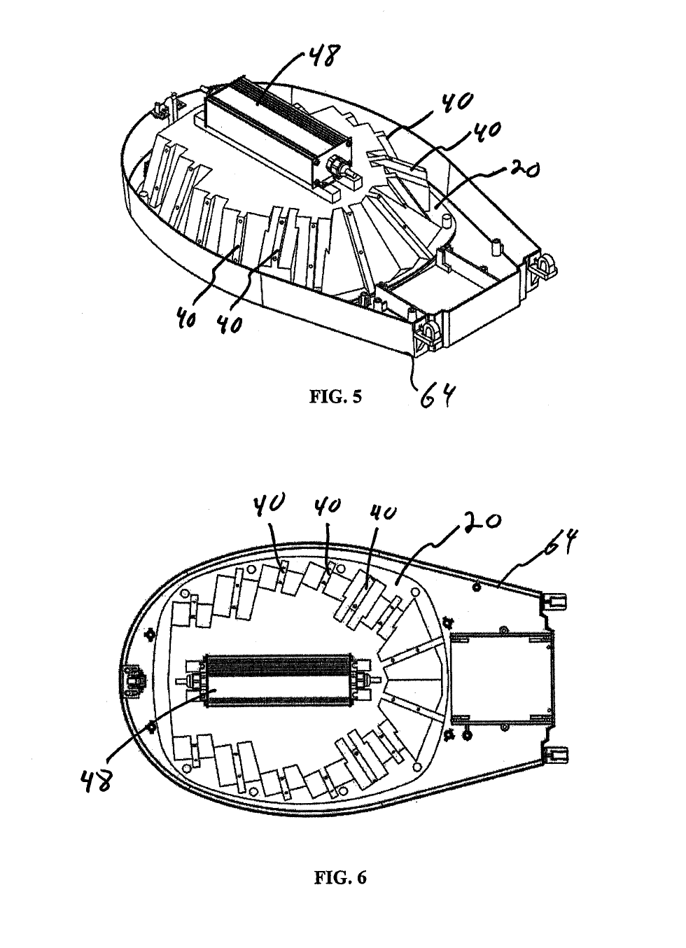

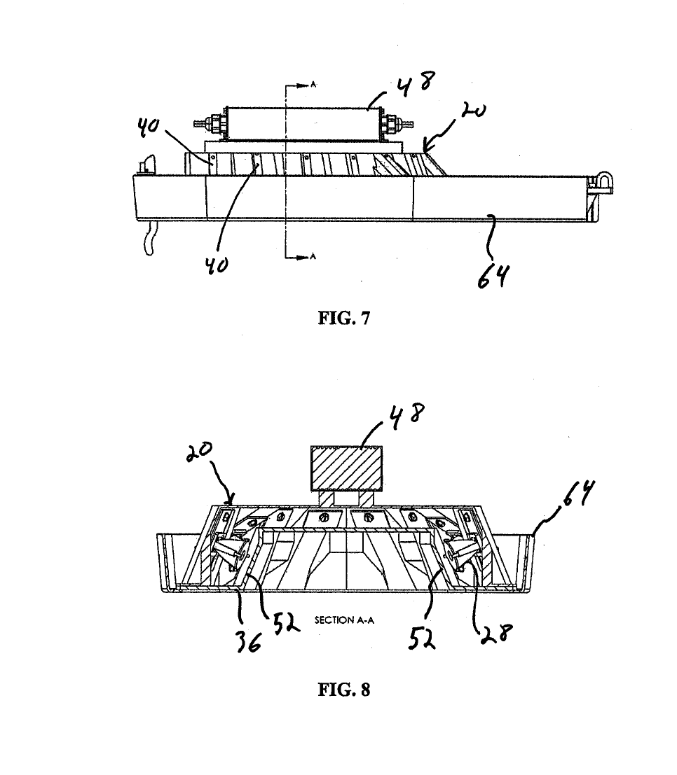

FIG. 4 illustrates a cobra head luminaire 60 having an aiming platform and refractor 36 mounted thereto. The retrofit assembly that comprises the aiming platform 20, refractor 36 fit into the lower luminaire housing 64 in place of the previously installed refractor. The luminaire 60 also includes an upper luminaire housing 68 and a mounting arm 72. FIGS. 5-8 illustrate the aiming platform 20, refractor 36, and associated components as mounted to the lower luminaire housing.

In the exemplary embodiment of FIGS. 1-8, the aiming platform and the refractor are specifically sized and shaped so as to be able to drop in as a replacement for the existing refractor on an existing small cobra head. However, it will be understood that this is exemplary only, and the principles described herein are applicable to other types of luminaries. For example, while this exemplary embodiment would only meet the requirements of the “small horizontal-burning HID luminaires” or small cobra head, extension to other embodiments wherein retro-fit devices or mechanisms are designed to fit the other sizes of refractors described in C136.17-2005 is accomplished in other embodiments. Still other embodiments have variations on the size, number and orientation of the facets of the aiming platform, the size, number and shape of cooling fins, the size, number and form-factor of the power supply or supplies, the variations in the material compositions of any of the components, the size, number, and operating characteristics of the LEDs, and variation in form of the external protective lens, whether it be faceted, flat or some other shape as long as conformance with ANSI C136.17-2005 and/or its updates.

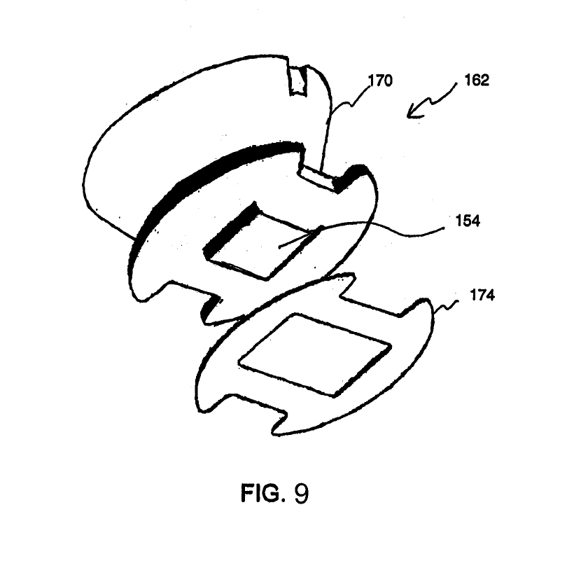

As discussed above, an LED light element may include a secondary optic element that provides collimation or other beam shaping to the light output from the LED. With reference now to FIG. 9, an illustration a collimating optic component 162 that is used as a secondary optic in one embodiment is discussed. The collimating optic 162 includes lens portion 170 that is adapted to receive an LED light element through aperture 154. The lens 170 is mounted to a substrate using an adhesive pad 174, in this embodiment. In some embodiments, frensel type lenses may be attached to the lens 170 to further shape the light output. As mentioned above, the secondary optic component, in combination with optical spreading and/or steering elements of other light elements, can be used to achieve a desired output by using an appropriate combination of uncollimated, narrowly collimated, wide angle and/or oval projection LED beam patterns. As will be readily understood by one of skill in the art, other types of secondary optics may be used depending upon the desired output beam of a particular light element.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A solid state lamp assembly adapted to replace an existing non-solid state lamp assembly installed in a street light, comprising:
an aiming platform adapted to be mounted to an existing mounting assembly of a street light, comprising a plurality of mounting surfaces, the plurality of mounting surfaces each comprising a generally planar surface on a first side and a heat dissipating element on a second side;
at least one solid state light element mounted to the first side of each mounting surface, each of at least a subset of the plurality of light elements providing light output along a respective primary axis that intersects a centerline of the housing, the output of the plurality of solid state light elements combining to provide an output illumination pattern.

2. The lamp assembly of claim 1, wherein the solid state light elements comprise one or more light emitting diodes (LEDs).

3. The lamp assembly of claim 2, wherein the LEDs are mounted to thermally conductive printed circuit boards mounted on the first side of respective mounting surfaces.

4. The lamp assembly of claim 2, wherein at least one of the solid state light elements further comprise secondary optics.

5. The lamp assembly of claim 1, further comprising an external protective lens mounted to the aiming platform.

6. The lamp assembly of claim 1, wherein the planar surfaces of the first side of the mounting surfaces each have different angles relative planar surfaces of other of the plurality of mounting surfaces.

5. The lamp assembly of claim 1, wherein the aiming platform is adapted to be mounted in place of a pre-existing refractor of a cobra head street luminaire.

6. The lamp assembly of claim 5, wherein the aiming platform meets the mechanical mounting requirements of a refractor in a cobra head luminaire according to American National Standards Institute standard ANSI C136.17-2005.

7. The lamp assembly of claim 1, wherein the heat dissipating element comprises a heat dissipating fin located on the second side of the mounting surface.

8. The lamp assembly of claim 7, wherein the heat dissipating fin comprises one or more apertures to secure the solid state light element to the first side of the mounting surface.

9. The lamp assembly of claim 7, wherein the heat dissipating fin provides additional structural support to the respective mounting surface.

10. The lamp assembly of claim 1, wherein an array of solid state light elements are mounted to the first side of at least one of the plurality of mounting surfaces.

11. The lamp assembly of claim 10, wherein each solid state light element of the array of solid state light elements provides light output along a primary axis that is substantially parallel to the primary axis of the other solid state light elements in the array.

12. The lamp assembly of claim 1, further comprising a power supply located on a top surface of the housing and electrically interconnected in power supplying communication with each of the solid state light elements.

13. The lamp assembly of claim 12, further comprising an adaptor cable adapted to connect the power supply to an existing power connection for a street lamp assembly.

14. A lamp assembly, comprising:
a housing adapted to be mounted in place of a refractor in an existing street light fixture and comprising a plurality of mounting surfaces that each have a first side and a second side;
a plurality of heat dissipation elements located on the second sides of the mounting surfaces; and
a plurality of solid state light elements mounted to the first sides of the mounting surfaces, each the plurality of light elements providing light output along a respective primary axis that is substantially orthogonal to a respective plane of the first side, the output of the plurality of solid state light elements combining to provide an output illumination pattern.

15. The lamp assembly of claim 14, wherein at least one of the plurality of solid state light elements comprise a collimating component that collimates light produced by the associated solid state light element.

16. The lamp assembly of claim 14, wherein the street light fixture is a cobra head street light.

17. The lamp assembly of claim 14, wherein the housing meets the mechanical mounting requirements of a refractor in a cobra head luminaire according to American National Standards Institute standard ANSI C136.17-2005.

18. The lamp assembly of claim 14, wherein the heat dissipating element comprises a heat dissipating fin located on the second side of the mounting surface.

19. The lamp assembly of claim 14, wherein an array of solid state light elements are mounted to the first side of at least one of the plurality of mounting surfaces.

20. The lamp assembly of claim 19, wherein each solid state light element of the array of solid state light elements provides light output along a primary axis that is substantially parallel to the primary axis of the other solid state light elements in the array.
